(19) United States
(12) Patent Application Publication
(10) Pub. No.: US 2016/0301632 A1
(43) Pub. Date: Oct. 13, 2016

(54) METHOD AND SYSTEM FOR BURST BASED PACKET PROCESSING

(71) Applicant: Telefonaktiebolaget L M Ericsson (publ), Stockholm (SE)

(72) Inventors: Prashant ANAND, BANGALORE (IN); Ashwani Kumar MEHRA, BANGALORE (IN)

(21) Appl. No.: 14/681,876

(22) Filed: Apr. 8, 2015

(51) Int. Cl. H04L 12/861; H04L 12/803

(52) U.S. Cl. CPC H04L 49/90; H04L 47/125

(57) ABSTRACT

In one embodiment, a method includes storing received packets at an electronic device in a plurality of packet buffers based on hashing the packets, where each of the plurality of packet buffers is implemented as a hash bucket of a hash table. The method includes identifying a packet buffer that has stored packets, selecting a first processing thread from a plurality of processing threads based on a load balancing mechanism, forwarding a plurality of packets from the identified packet buffer to the first processing thread, and setting an indication that the identified packet buffer is mapped to the first processing thread. The method includes determining that the first processing thread has completed processing the plurality of packets, selecting either the first processing thread or a second processing thread for processing subsequent packets from the identified packet buffer, and maintaining or updating the indication based on the selection.

### FIELD

The embodiments of the invention are related to the field of networking. More specifically, the embodiments of the invention relate to a method and system for burst-based packet processing.

### BACKGROUND

Load balancing is a computer networking method for distributing workloads across multiple computing resources, such as computers, a computer cluster, network links, central processing units or disk drives. Load balancing aims to optimize resource use, maximize throughput, minimize response time, and avoid overload of any one of the resources. Using multiple components with load balancing instead of a single component may increase reliability through redundancy. Thus, load balancing is widely used to enhance scalability and availability of telecommunication and information technology (IT) applications.

For packet processing, load balancing is typically performed through packet processing threads, where each of a plurality of packet processing threads in a packet processor processes a portion of received packets. In a typical load balancing implementation for packet processing, received packets are dispatched to the plurality of packet processing threads according to a load balancing policy to determine to which packet processing threads the packets are to be sent.

Generally, the load balancing policy causes the packets to be forwarded to the plurality of packet processing threads on a per-packet basis.

### SUMMARY

A method is disclosed to process packets in an electronic device. The method includes storing received packets at the electronic device in a plurality of packet buffers based on hashing the packets, where each of the plurality of packet buffers is implemented as a hash bucket of a hash table. The method includes identifying, from the plurality of packet buffers, a packet buffer that has stored packets; selecting a first processing thread from a plurality of processing threads of the electronic device based on a load balancing mechanism; forwarding a plurality of packets from the identified packet buffer to the first processing thread; and setting an indication that the identified packet buffer is mapped to the first processing thread. The method continues with determining that the first processing thread has completed processing the plurality of packets, and selecting either the first processing thread or a second processing thread from the plurality of processing threads for processing subsequent packets from the identified packet buffer based on the load balancing mechanism in response to determining that the first processing thread has completed processing the plurality of packets and that the identified packet buffer has stored the subsequent packets. The method further includes maintaining or updating the indication based on the selection of either the first processing thread or the second processing thread.

An electronic device is disclosed to process packets. The electronic device includes a processor including a plurality of processing threads; and a non-transitory machine-readable storage medium coupled to the processor. The electronic device is operative to store received packets in a plurality of packet buffers based on hashing the packets, where each of the plurality of packet buffers is implemented as a hash bucket of a hash table. The electronic device is operative to identify, from the plurality of packet buffers, a packet buffer that has stored packets, select a first processing thread from the plurality of processing threads based on a load balancing mechanism, forward a plurality of packets from the identified packet buffer to the first processing, and set an indication that the identified packet buffer is mapped to the first processing thread. The electronic device is operative to determine that the first processing thread has completed processing the plurality of packets, and select either the first processing thread or a second processing thread from the plurality of processing threads for processing subsequent packets from the identified packet buffer based on the load balancing mechanism in response to the determination that the first processing thread has completed processing the plurality of packets and that the identified packet buffer has stored the subsequent packets. The electronic device is operative to maintain or update the indication based on the selection of either the first processing thread or the second processing thread.

A non-transitory machine-readable storage medium for processing packets is disclosed. The medium has instructions stored therein, which when executed by a processor, cause the processor to perform operations in an electronic device. The operations include storing received packets in a plurality of packet buffers based on hashing the packets, where each of the plurality of packet buffers is implemented as a hash bucket of a hash table. The operations also include identifying, from the plurality of packet buffers, a packet buffer that has stored packets; selecting a first processing thread from a plurality of processing threads of the electronic device based on a load balancing mechanism; forwarding a plurality of packets from the identified packet buffer to the first processing thread; and setting an indication that the identified packet buffer is mapped to the first processing thread. The operations continue with determining that the first processing thread has completed processing the plurality of packets, and selecting either the first processing thread or a second processing thread from the plurality of processing threads for processing subsequent packets from the identified packet buffer based on the load balancing mechanism in response to determining that the first processing thread has completed processing the plurality of packets and that the identified packet buffer has stored the subsequent packets. The operations further include maintaining or updating the indication based on the selection of either the first processing thread or the second processing thread.

Embodiments of the disclosed techniques provide ways to improve load balancing through a plurality of processing threads of a processor. Through embodiments of the disclosed techniques, packets from a traffic flow tend to be processed by the same processing thread, and thus packet processing performance through the plurality of processing threads is improved.

### BRIEF DESCRIPTION OF THE DRAWINGS

The present invention is illustrated by way of example, and not by way of limitation, in the figures of the accompanying drawings in which like references indicate similar elements.

FIG. 1 illustrates burst-based packet processing according to one embodiment of the invention.

FIG. 2 is a flow diagram illustrating the operations of burst-based packet processing according to one embodiment of the invention.

FIG. 3 is a flow diagram illustrating switching to per-packet-based packet processing from per-burst-based packet processing according to one embodiment of the invention.

FIG. 4 is a flow diagram illustrating the operations of determining that a processing thread has completed processing packets according to one embodiment of the invention.

FIG. 5A illustrates connectivity between network devices (NDs) within an exemplary network, as well as three exemplary implementations of the NDs, according to some embodiments of the invention.

FIG. 5B illustrates an exemplary way to implement a special-purpose network device according to some embodiments of the invention.

FIG. 5C illustrates various exemplary ways in which virtual network elements (VNEs) may be coupled according to some embodiments of the invention.

FIG. 5D illustrates a network with a single network element (NE) on each of the NDs, and within this straight forward approach contrasts a traditional distributed approach (commonly used by traditional routers) with a centralized approach for maintaining reachability and forwarding information (also called network control), according to some embodiments of the invention.

FIG. 5E illustrates the simple case of where each of the NDs implements a single NE, but a centralized control plane has abstracted multiple of the NEs in different NDs into (to represent) a single NE in one of the virtual network(s), according to some embodiments of the invention.

FIG. 5F illustrates a case where multiple VNEs are implemented on different NDs and are coupled to each other, and where a centralized control plane has abstracted these multiple VNEs such that they appear as a single VNE within one of the virtual networks, according to some embodiments of the invention.

FIG. 6 illustrates a general purpose control plane device with centralized control plane (CCP) software 650), according to some embodiments of the invention.

### DETAILED DESCRIPTION

In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. However, it is understood that embodiments of the invention may be practiced without these specific details. In other instances, well-known circuits, structures and techniques have not been shown in detail in order not to obscure the understanding of this description. It will be appreciated, however, by one skilled in the art that the invention may be practiced without such specific details. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments of the invention. However, such notation should not be taken to mean that these are the only options or optional operations, and/or that blocks with solid borders are not optional in certain embodiments of the invention.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other. A “set,” as used herein refers to any positive whole number of items including one item.

An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, read only memory (ROM), flash memory devices, phase change memory) and machine-readable transmission media (also called a carrier) (e.g., electrical, optical, radio, acoustical or other form of propagated signals—such as carrier waves, infrared signals). Thus, an electronic device (e.g., a computer) includes hardware and software, such as a set of one or more processors coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set or one or more physical network interface(s) to establish network connections (to transmit and/or receive code and/or data using propagating signals) with other electronic devices.

A network device (ND) is an electronic device that communicatively interconnects other electronic devices on the network (e.g., other network devices, end-user devices). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video). As explained in more details herein below, a network element may be implemented in one or more network devices, and a network device may implement one or more network elements.

The operations in the flow diagrams will be described with reference to the exemplary embodiments of the other figures. However, it should be understood that the operations of the flow diagrams can be performed by embodiments of the invention other than those discussed with reference to the other figures, and the embodiments of the invention discussed with reference to these other figures can perform operations different than those discussed with reference to the flow diagrams.

Challenges in Packet Processing

An electronic device may contain one or more processors to process received packets, and each of such a processor may be referred to as a packet processor. A packet processor typically contains multiple threads (referred to as processing threads or packet processing threads) running on multiple cores. The multiple processing threads can process multiple received packets in parallel concurrently, resulting in better packet processing performance. The principle of multiple processing threads processing packets is similar to multiple threads in the general computer architecture, where the multiple threads may share a single core or multiple cores of a processing unit or multiple processing units. The multiple threads may use a run-to-complete model, where all the threads run the same instance of processing/forwarding software (e.g., ingress/egress or collapsed ingress-egress functionality), and each thread performs a complete set of applicable lookup and forwarding functions on packets.

In packet processing, the multiple processing threads typically load balance received packets on a per-packet basis. The per-packet-based load balancing may result in a sub-optimal performance as packets are often associated with traffic flows in a data network. A traffic flow may be defined as a set of packets whose headers match a given pattern of bits, and a traffic flow may be identified by a set of attributes embedded in one or more packets of the traffic flow. A traffic flow often contains state information that needs to be maintained. For example, a traffic flow may be a communication session (e.g., an Internet Protocol Security (IPSec) session). The state information of the traffic flow may include a registration state of a user associated with the communication session, a user session identifier of the communication session, a dialogue state, and etc. The state information changes while the communication session is in progress, and the associated traffic flow needs packets of the traffic flow to be synchronized with the updated state information. When the load balancing is performed on a per-packet basis, the packets of a traffic flow are likely processed by different processing threads. These different processing threads need to be synchronized with regard to the state of the traffic flow in processing these packets. The synchronization of multiple processing threads is challenging.

One approach to synchronize the multiple processing threads is to utilize a locking mechanism. When a first processing thread processes a packet of a traffic flow, the first processing thread obtains a lock to update the state information. Once the first processing thread completes the update, the first processing thread releases the lock, and a second processing thread may obtain the lock and update the state information when the second processing thread processes another packet of the traffic flow. Through the locking mechanism, the state information of the traffic flow may be maintained. However, such locking mechanism is detrimental to the processing efficiency of the multiple processing threads, as the locking mechanism introduces additional latency (process time delay) and jitter/variance (process time differences) in processing the traffic flow.

Because of the challenges such as synchronizing multiple processing threads, it is desirable to process packets of a traffic flow in a single processing thread within the multiple processing threads. When the packets of the traffic flow are processed by the single processing thread, the state information of the traffic flow may be maintained without referring to any other processing thread, thus no locking mechanism is needed. Additionally, the packets will be processed by the processing thread in the order in which the packets are received. Thus, the packets, after being processed by the processing thread, do not need to be reordered. Furthermore, the processing threads generally use caches, a translation lookaside buffer (TLB), and other common mechanisms in computing architectures to facilitate packet processing. These mechanisms are typically most efficient when the processed data have temporal and/or spatial localities. The packets of the traffic flow typically have temporal and/or spatial localities, and thus processing of those packets of the traffic flow in a processing thread (i.e., a single processing thread) will likely be more efficient for the overall performance of the packet processing.

Burst-Based Packet Processing

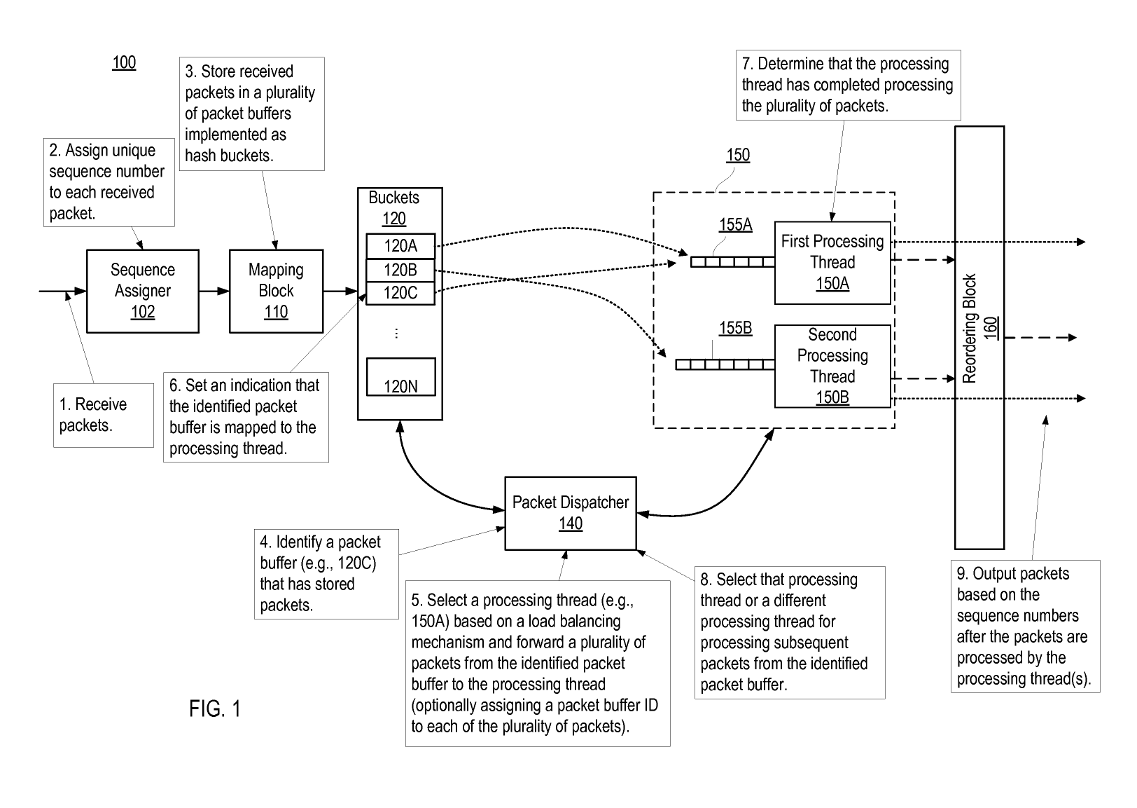

One way to process packets of a traffic flow in a processing thread (i.e., a single processing thread) within the multiple processing threads is to process received packets on a per-burst basis. FIG. 1 illustrates burst-based packet processing according to one embodiment of the invention. The process 100 may be implemented within one or more electronic devices, which contain multiple functional blocks including a sequence assigner 102, a mapping block 110, one or more buckets 120, a packet dispatcher 140, a plurality of processing threads 150 (including a first processing thread 150A and a second processing thread 150B), and a reordering block 160. Task boxes 1 to 9 illustrate the order in which operations are performed according to one embodiment of the invention.

At task box 1, packets are received at the sequence assigner 102, which assigns a unique sequence number to each of the received packets at task box 2. The unique sequence number may be used later to order the received packets so that the received packets exit the process 100 in the same order in which the packets are received at the sequence assigner 102. After assignment by the sequence assigner 102, the packets are then forwarded to the mapping block 110, which stores the received packets in a plurality of packet buffers based on hashing the packets at task box 3. Each of the plurality of packet buffers is implemented as a hash bucket of a hash table as illustrated by buckets 120A-120N.

The hashing of the packets may be performed in a variety of ways. For example, information in the packet headers such as source address, destination address, and/or port numbers may be used as indexes to map the packets to a hash bucket of the hash table. Each packet will be mapped to a single bucket of the hash table through a hash function. Each bucket 120 may be associated with a storage space to store one or more packets, and each bucket may be identified by an identifier (e.g., a HashBucketId). Each bucket includes a queue to store packets.

The status of the packet buffers are monitored by the packet dispatcher 140, which forwards packets from the packet buffers to the processing threads 150. At task box 4, the packet dispatcher 140 identifies a packet buffer (e.g., a packet buffer implemented as hash bucket 120C) that has stored packets. It is to be noted that typically the number of packet buffers is far larger than the number of processing threads so that one processing thread may process packets from multiple packet buffers concurrently.

At task box 5, the packet dispatcher 140 selects a processing thread (i.e., a single processing thread) from the plurality of processing threads 150 based on a load balancing mechanism and forwards a plurality of packets from the identified packet buffer to the selected processing thread. In one embodiment, each of the plurality of packets is assigned a packet buffer identifier (e.g., the HashBucketId) indicating the identified packet buffer. The packet buffer identifier may be added as metadata of the packet and forwarded along with the packet to the selected processing thread. It is to be noted that each processing thread in the multiple processing threads 150 includes a queue (such as queues 155A and 155B), which stores the packets forwarded from the packet buffers prior to the packets being processed by the processing thread. Typically, the queue lengths of the packet buffers are much longer than the queue lengths of the processing threads.

The load balancing mechanism may be a type of round robin, where a processing thread with a lighter load takes precedence over another processing thread with a heavier load. When making the selection of a processing thread, some types of round robin may also consider the capacities/health statuses of the plurality of processing threads. That is, weights may be added to the plurality of processing threads to take other factors into consideration, and the resulting weighted scores of processing threads may be utilized by the packet dispatcher 140 to determine which processing thread is to be selected. The weighted round-robin scheduling selects the processing thread with the highest score to receive the forwarded plurality of packets. The load balancing mechanism may also be a random selection for simplicity of selection or other more sophisticated load balancing mechanisms. The principle of the disclosed technique is agnostic to the chosen load balancing mechanism.

The plurality of packets may be all the packets stored in the identified packet buffer, and the plurality of packets may also be a portion of the packets stored in the identified packet buffer. For example, the packet dispatcher 140 may have a limit on how many packets the packet dispatcher 140 may forward to a single processing thread at one time. The packet dispatcher 140 thus forwards the packets stored in the identified packet buffer up to the limit, and the remaining packets stay in the identified packet buffer. The packet dispatcher 140 may dispatch the remaining packets and future arrived packets stored in the identified packet buffer in a subsequent dispatch.

At task box 6, an indication is set to indicate that the identified packet buffer is mapped to the processing thread. The indication is set by the packet dispatcher 140 in one embodiment. The indication may be stored in the packet dispatcher 140 or in the identified packet buffer. The indication may be implemented as a bit vector (e.g., a bit mask) or a table associated with the identified packet buffer. The indication indicates that the identified packet buffer is currently associated with the processing thread, and packets in the identified packet buffer are not to be forwarded to any other processing thread.

At task box 7, it is determined that the processing thread has completed processing the plurality of packets from the identified packet buffer. The processing thread may process packets from multiple packet buffers concurrently, and the processing thread may identify the packets from a specific packet buffer by checking the packet buffer identifier of the packets. The completion of processing the plurality of packets from the identified packet buffer may be determined by using and monitoring a counter for the identified packet buffer, which increments when packets are received from the identified packet buffer and decrements when a packet from the identified packet buffer has been completely processed by the processing thread. When the counter equals zero, the processing thread has completed processing the plurality of packets from the identified packet buffer. The counter may be implemented at the identified packet buffer, the packet dispatcher 140, or the associated processing thread, and the counter counts outstanding packets forwarded to one and only one processing thread, which is indicated by the indication set at task box 6.

At task box 8, in response to determining that the processing thread has completed processing the plurality of packets from the identified packet buffer and that the identified packet buffer has stored more packets, either the processing thread or a different processing thread may be selected for processing the subsequent packets from the identified packet buffer based on the same load balancing mechanism used earlier to select the processing thread at task box 5. In other words, the subsequent packets may be processed by the same or a different processing thread, and thus the subsequent packets may be viewed as being treated as a different traffic flow. Based on the selection of the same or a different processing thread, the indication set at task box 6 is maintained or updated. That is, the indication is maintained when the processing thread selected at task box 5 is selected again at task box 8, while the indication is updated to indicate that the identified packet buffer is mapped to a different processing thread otherwise.

At task box 9, the packets processed by the processing thread(s) are output based on the sequence numbers so that the packets exit the process 100 in the order in which the packets are received at the sequence assigner 102.

Additionally, sometimes a burst of traffic causes a packet buffer to be backlogged for a long period of time. The heavy traffic flow (sometimes referred to as an elephant flow) may congest a selected processing thread while other processing threads of the plurality of processing threads are idle if packets are forwarded from the packet buffers to the processing threads based on bursts of packets, and the congestion reduces packet processing efficiency. In that case, it is preferable to revert back to the load balancing from the per-burst basis to a per-packet basis. Thus, in one embodiment, when it is determined that a packet buffer is congested (e.g., through determining that a length of a queue of the packet buffer is over a predetermined threshold) for a predetermined period of time, the packet dispatcher 140 switches to dispatching (i.e., forwarding) packets from the packet buffer on a per-packet basis. When it is determined that the packet buffer is no longer congested (e.g., through determining that the length of the queue of the packet buffer is under the predetermined threshold for a predetermined period of time), the packet dispatcher 140 may switch back to dispatching packets from the packet buffer on a per-burst basis as discussed herein above with relation to task boxes 1-8. It is to be noted that for an embodiment without forwarding the packets on a per-packet basis to address the heavy traffic flow, the reordering block 160 performs only a trivial task of ordering the processed packets from the same processing threads. In such case, the sequence assigner 102 and reordering block 160 may not be needed.

It is to be noted that the different functional blocks of FIG. 1 may be implemented in a single electronic device or they may be implemented by multiple electronic devices, and some functional blocks may not be needed in some embodiments. For example, the sequence assigner 102 and the reordering block 160 may not be needed in one embodiment. In one embodiment, the packet dispatcher 140 is implemented in an electronic device that is different from an electronic device implementing the multiple processing threads 150 and buckets 120 (e.g., the packet dispatcher 140 may be implemented in a software-defined networking (SDN) controller while the other functional blocks are implemented in a forwarding element managed by the SDN controller).

Flow Diagrams

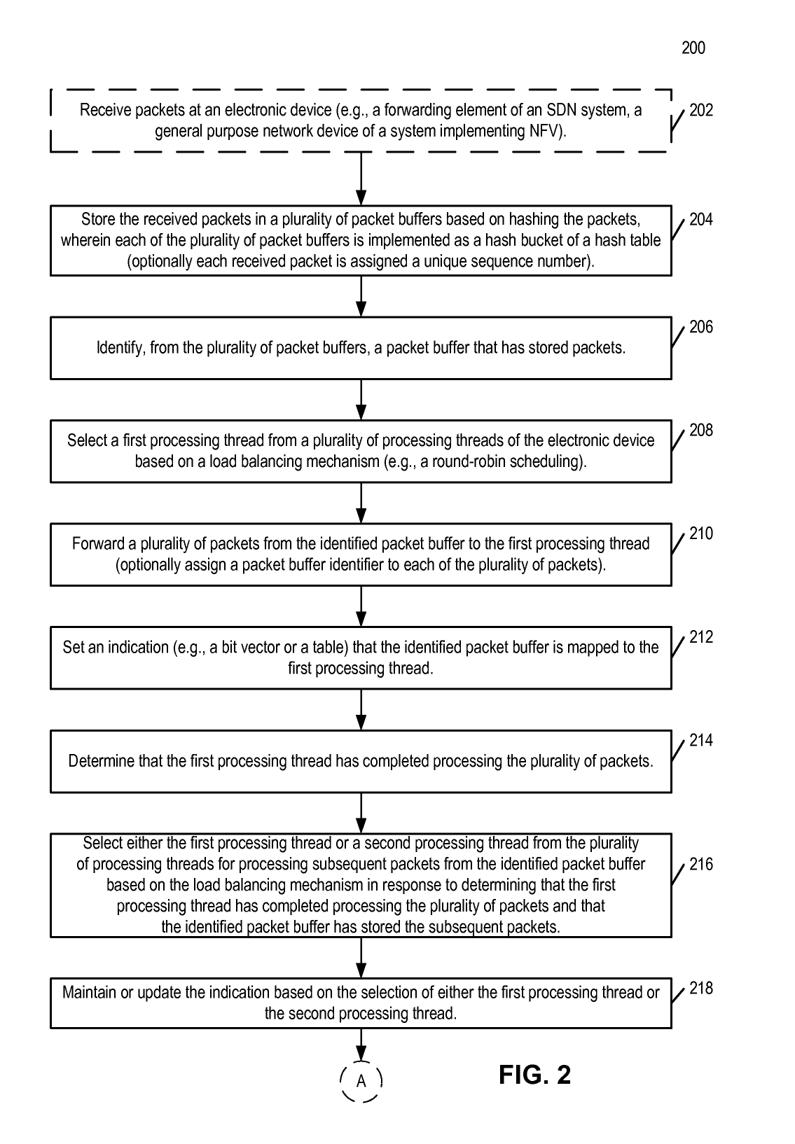

FIG. 2 is a flow diagram illustrating the operations of burst-based packet processing according to one embodiment of the invention. Method 200 may be performed in one or more electronic devices, each of which may be a special purpose network device, or a general purpose network device of a system implementing network function virtualization (NFV).

At reference 202, packets are received at an electronic device. At reference 204, the received packets are stored in a plurality of packet buffers based on hashing the packets, where each of the plurality of packet buffers is implemented as a hash bucket of a hash table. The hashing of the packets is discussed herein above in relation to task box 3 of FIG. 1. Additionally, in one embodiment, each of the received packets is assigned a unique sequence number based on an order of the packets being received at the electronic device.

At reference 206, a packet buffer that has stored packets is identified from the plurality of packet buffers. At reference 208, a first processing thread (i.e., a first single processing thread) from a plurality of processing threads of the electronic device is selected based on a load balancing mechanism. The selection based on the load balancing mechanism is discussed herein above in relation to task box 5 of FIG. 1. At reference 210, a plurality of packets from the identified packet buffer is forwarded to the selected first processing thread. In one embodiment, each of the plurality of packets is assigned a packet buffer identifier indicating the identified packet buffer from which the packets are forwarded to the first processing thread.

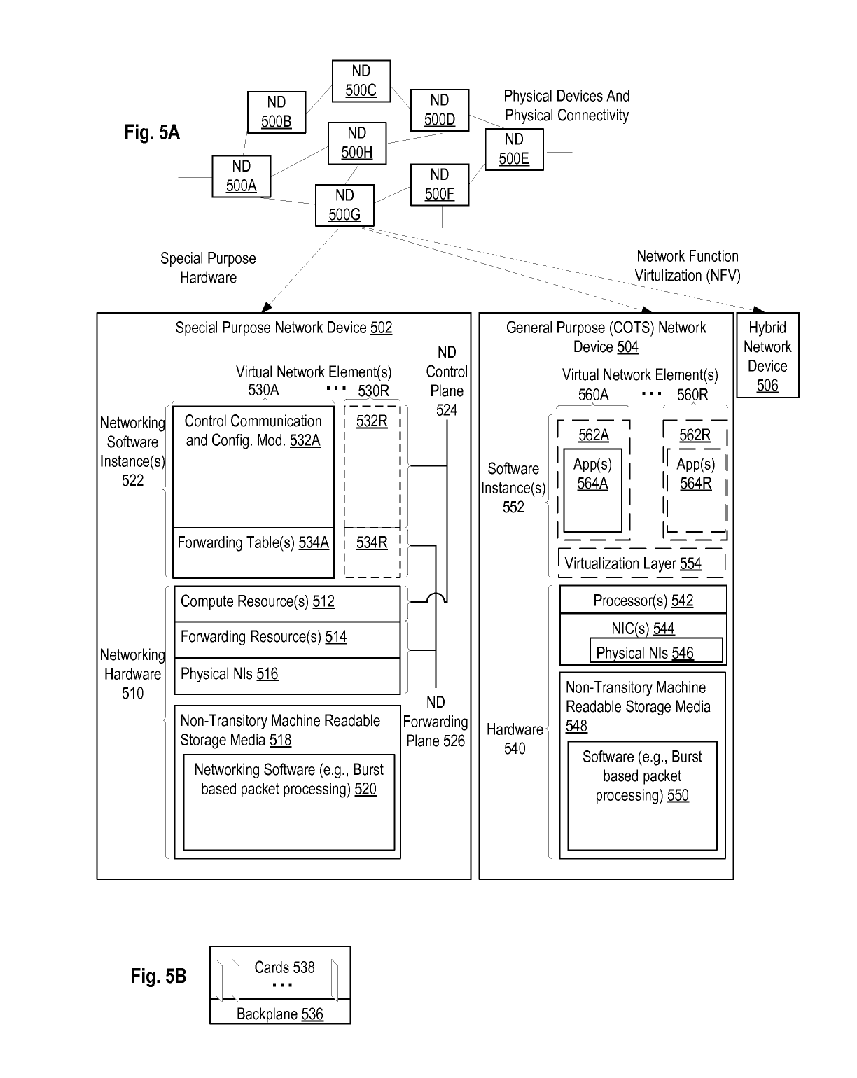

At reference 212, an indication is set to indicate that the identified packet buffer is mapped to the first processing thread. The setting of the indication is discussed herein above in relation to task box 6 of FIG. 1. At reference 214, it is determined that the first processing thread has completed processing the plurality of packets from the identified packet buffer. The determination may be based on a counter for the identified packet buffer as discussed herein above and also in relation to FIG. 4 below. The processing of packets at the first processing thread may include performing operations, such as packet validation, service performance (e.g., access control list (ACL) and quality of service (QoS) enforcement), forwarding table lookups, and forwarding the packets.

At reference 216, in response to the determination that the first processing thread has completed processing the plurality of packets from the identified packet buffer and that the identified packet buffer has stored subsequent packets, either the first processing thread or a second processing thread (i.e., a second single processing thread) is selected from the plurality of processing threads for processing the subsequent packets from the identified packet buffer based on a load balancing mechanism (e.g., the same load balancing mechanism at reference 208). The subsequent packets are then forwarded to the first or the second processing thread for processing. At reference 218, the indication at reference 212 is maintained or updated based on the selection of either the first processing thread or the second processing thread.

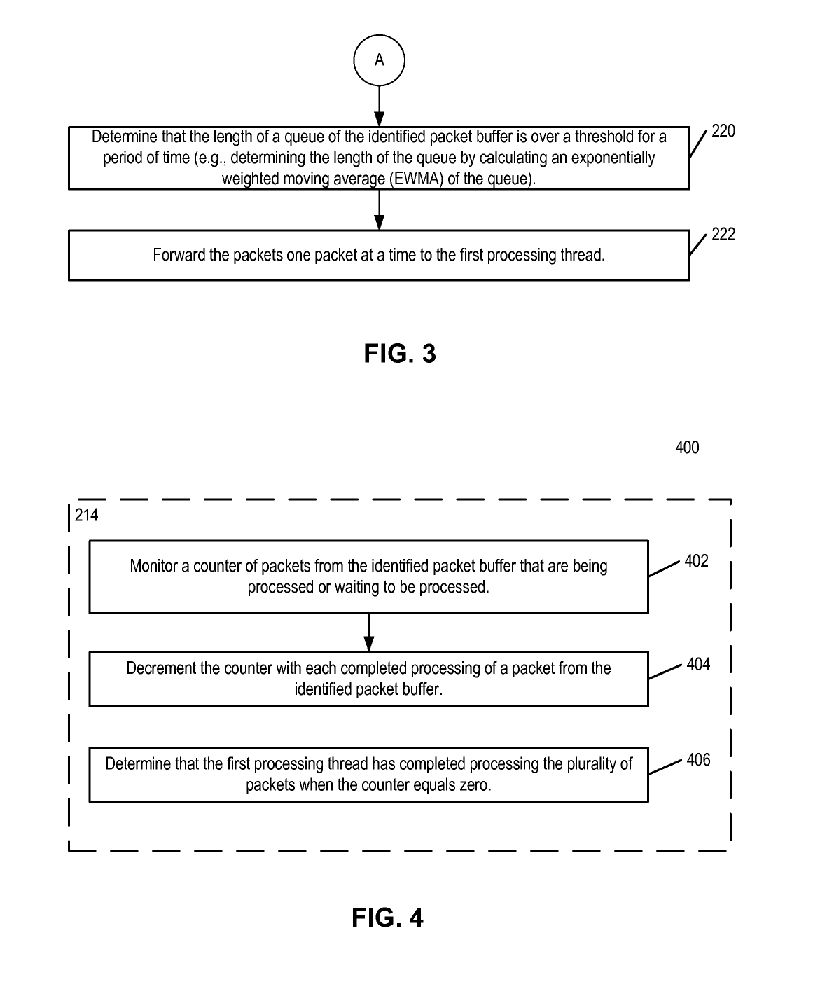

Optionally, method 200 continues to FIG. 3, which is a flow diagram illustrating the switching to per-packet-based packet processing from per-burst-based packet processing according to one embodiment of the invention. Referring to FIG. 3, at reference 220, it is determined that a length of a queue of the identified packet buffer is over a threshold for a period of time. The length of the queue is determined by calculating an exponentially weighted moving average (EWMA) of the queue in one embodiment. The EWMA queue length provides a measure of the average queue length over a determined period of time and thus accounts for and ignores short bursts of packets in otherwise well-behaved packet buffers.

At reference 222, the received packets from the identified packet buffer are forwarded one packet at a time instead of forwarding the plurality of packets to the first processing thread. The forwarding of packets one packet at a time may be based on the load balancing mechanism used in reference 208, or the forwarding may use a different load balancing mechanism.

Through switching to forwarding packets on a per-packet basis when the packet buffer is congested, packets from a traffic flow (i.e., a single traffic flow) are processed by multiple processing threads during congestion, and thus the congestion can be alleviated at the expense of lower processing efficiency (as synchronization among the multiple processing threads is needed). Once the congestion is addressed (e.g., the length of the queue of the packet buffer is below a threshold for another period of time), the system may revert back to the burst-based packet processing discussed in relation to references 202-218.

It is to be noted that references 202-222 of method 200 may be performed by different functional blocks such as the ones discussed in relation to FIG. 1.

FIG. 4 is a flow diagram illustrating the operations of determining that a processing thread (i.e., a single processing thread) has completed processing packets according to one embodiment of the invention. Method 400 is an implementation of reference 214 of FIG. 2 in one embodiment. At reference 402, a counter of packets within the plurality of packets from the identified packet buffer is monitored. The counter of packets from the identified packet buffer counts the number of packets that are being processed or that are waiting to be processed by the processing thread.

At reference 404, the counter is decremented with each completed processing, by the processing thread, of a packet from the identified packet buffer. At reference 406, it is determined that the processing thread has completed processing the plurality of packets from the identified packet buffer when the counter equals zero.

Through counting the number of packets from the identified packet buffer and using the indication that the identified packet buffer is mapped to the processing thread, the packets in the identified packet buffer cannot be forwarded to a different processing thread while at least one packet from the identified packet buffer is being processed or waiting to be processed. Thus, without inspecting the packets to understand whether the packets from a packet buffer are indeed from a same traffic flow, the disclosed techniques drain a burst of packets from the packet buffer and queue the burst of packets to be processed by a processing thread (i.e., a single processing thread) of a plurality of processing threads. Thus, the disclosed techniques effectively load balance the packet processing on a per-burst basis. When the counter of packets from the packet buffer waiting to be processed and currently in processing equals zero at the processing thread, it means that the burst packets have been completed processed, and thus the subsequent packets from the packet buffer are free to be forwarded to a different processing thread if that forwarding achieves a better load balance based on the load balancing mechanism.

### SDN and NFV Environment Utilizing Embodiment of the Invention

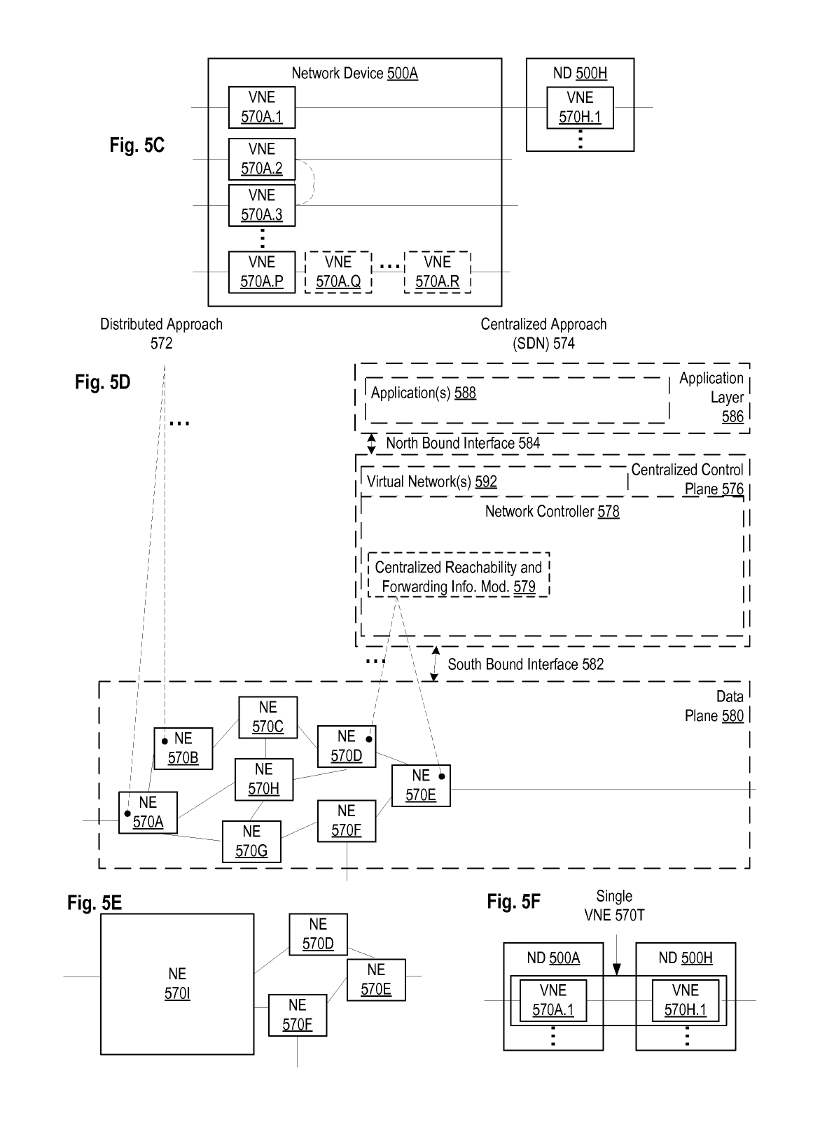

Embodiments of the invention may be utilized in a SDN and/or NFV network containing network devices. FIG. 5A illustrates connectivity between network devices (NDs) within an exemplary network, as well as three exemplary implementations of the NDs, according to some embodiments of the invention. FIG. 5A shows NDs 500A-H, and their connectivity by way of lines between A-B, B-C, C-D, D-E, E-F, F-G, and A-G, as well as between H and each of A, C, D, and G. These NDs are physical devices, and the connectivity between these NDs can be wireless or wired (often referred to as a link). An additional line extending from NDs 500A, E, and F illustrates that these NDs act as ingress and egress points for the network (and thus, these NDs are sometimes referred to as edge NDs; while the other NDs may be called core NDs).

Two of the exemplary ND implementations in FIG. 5A are: 1) a special-purpose network device 502 that uses custom application—specific integrated—circuits (ASICs) and a proprietary operating system (OS); and 2) a general purpose network device 504 that uses common off-the-shelf (COTS) processors and a standard OS.

The special-purpose network device 502 includes networking hardware 510 comprising compute resource(s) 512 (which typically include a set of one or more processors), forwarding resource(s) 514 (which typically include one or more ASICs and/or network processors), and physical network interfaces (NIs) 516 (sometimes called physical ports), as well as non-transitory machine readable storage media 518 having stored therein networking software 520. A physical NI is hardware in a ND through which a network connection (e.g., wirelessly through a wireless network interface controller (WNIC) or through plugging in a cable to a physical port connected to a network interface controller (NIC)) is made, such as those shown by the connectivity between NDs 500A-H. During operation, the networking software 520 may be executed by the networking hardware 510 to instantiate a set of one or more networking software instance(s) 522. Each of the networking software instance(s) 522, and that part of the networking hardware 510 that executes that network software instance (be it hardware dedicated to that networking software instance and/or time slices of hardware temporally shared by that networking software instance with others of the networking software instance(s) 522), form a separate virtual network element 530A-R. Each of the virtual network element(s) (VNEs) 530A-R includes a control communication and configuration module 532A-R (sometimes referred to as a local control module or control communication module) and forwarding table(s) 534A-R, such that a given virtual network element (e.g., 530A) includes the control communication and configuration module (e.g., 532A), a set of one or more forwarding table(s) (e.g., 534A), and that portion of the networking hardware 510 that executes the virtual network element (e.g., 530A). The networking software 520 includes burst-based packet processing as discussed herein above in relation to FIGS. 1-4 in one embodiment.

The special-purpose network device 502 is often physically and/or logically considered to include: 1) a ND control plane 524 (sometimes referred to as a control plane) comprising the compute resource(s) 512 that execute the control communication and configuration module(s) 532A-R; and 2) a ND forwarding plane 526 (sometimes referred to as a forwarding plane, a data plane, or a media plane) comprising the forwarding resource(s) 514 that utilize the forwarding table(s) 534A-R and the physical NIs 516. By way of example, where the ND is a router (or is implementing routing functionality), the ND control plane 524 (the compute resource(s) 512 executing the control communication and configuration module(s) 532A-R) is typically responsible for participating in controlling how data (e.g., packets) is to be routed (e.g., the next hop for the data and the outgoing physical NI for that data) and storing that routing information in the forwarding table(s) 534A-R, and the ND forwarding plane 526 is responsible for receiving that data on the physical NIs 516 and forwarding that data out the appropriate ones of the physical NIs 516 based on the forwarding table(s) 534A-R.

FIG. 5B illustrates an exemplary way to implement the special-purpose network device 502 according to some embodiments of the invention. FIG. 5B shows a special-purpose network device including cards 538 (typically hot pluggable). While in some embodiments the cards 538 are of two types (one or more that operate as the ND forwarding plane 526 (sometimes called line cards), and one or more that operate to implement the ND control plane 524 (sometimes called control cards)), alternative embodiments may combine functionality onto a single card and/or include additional card types (e.g., one additional type of card is called a service card, resource card, or multi-application card). A service card can provide specialized processing (e.g., Layer 4 to Layer 7 services (e.g., firewall, Internet Protocol Security (IPsec) (RFC 4301 and 4309), Secure Sockets Layer (SSL)/Transport Layer Security (TLS), Intrusion Detection System (IDS), peer-to-peer (P2P), Voice over IP (VoIP) Session Border Controller, Mobile Wireless Gateways (Gateway General Packet Radio Service (GPRS) Support Node (GGSN), Evolved Packet Core (EPC) Gateway)). By way of example, a service card may be used to terminate IPsec tunnels and execute the attendant authentication and encryption algorithms. These cards are coupled together through one or more interconnect mechanisms illustrated as backplane 536 (e.g., a first full mesh coupling the line cards and a second full mesh coupling all of the cards).

Returning to FIG. 5A, the general purpose network device 504 includes hardware 540 comprising a set of one or more processor(s) 542 (which are often COTS processors) and network interface controller(s) 544 (NICs; also known as network interface cards) (which include physical NIs 546), as well as non-transitory machine readable storage media 548 having stored therein software 550. During operation, the processor(s) 542 execute the software 550 to instantiate one or more sets of one or more applications 564A-R. The networking software 520 includes burst-based packet processing as discussed herein above in relation to FIGS. 1-4 in one embodiment. While one embodiment does not implement virtualization, alternative embodiments may use different forms of virtualization—represented by a virtualization layer 554 and software containers 562A-R. For example, one such alternative embodiment implements operating system-level virtualization, in which case the virtualization layer 554 represents the kernel of an operating system (or a shim executing on a base operating system) that allows for the creation of multiple software containers 562A-R that may each be used to execute one of the sets of applications 564A-R. In this embodiment, the multiple software containers 562A-R (also called virtualization engines, virtual private servers, or jails) are each a user space instance (typically a virtual memory space); these user space instances are separate from each other and separate from the kernel space in which the operating system is run; the set of applications running in a given user space, unless explicitly allowed, cannot access the memory of the other processes. Another such alternative embodiment implements full virtualization, in which case: 1) the virtualization layer 554 represents a hypervisor (sometimes referred to as a virtual machine monitor (VMM)) or a hypervisor executing on top of a host operating system; and 2) the software containers 562A-R each represent a tightly isolated form of software container called a virtual machine that is run by the hypervisor and may include a guest operating system. A virtual machine is a software implementation of a physical machine that runs programs as if they were executing on a physical, non-virtualized machine; and applications generally do not know they are running on a virtual machine as opposed to running on a “bare metal” host electronic device, though some systems provide para-virtualization which allows an operating system or application to be aware of the presence of virtualization for optimization purposes.

The instantiation of the one or more sets of one or more applications 564A-R, as well as the virtualization layer 554 and software containers 562A-R if implemented, are collectively referred to as software instance(s) 552. Each set of applications 564A-R, corresponding software container 562A-R if implemented, and that part of the hardware 540 that executes them (be it hardware dedicated to that execution and/or time slices of hardware temporally shared by software containers 562A-R), forms a separate virtual network element(s) 560A-R.

The virtual network element(s) 560A-R perform similar functionality to the virtual network element(s) 530A-R—e.g., similar to the control communication and configuration module(s) 532A and forwarding table(s) 534A (this virtualization of the hardware 540 is sometimes referred to as network function virtualization (NFV)). Thus, NFV may be used to consolidate many network equipment types onto industry standard high volume server hardware, physical switches, and physical storage, which could be located in Data centers, NDs, and customer premise equipment (CPE). However, different embodiments of the invention may implement one or more of the software container(s) 562A-R differently. For example, while embodiments of the invention are illustrated with each software container 562A-R corresponding to one VNE 560A-R, alternative embodiments may implement this correspondence at a finer level granularity (e.g., line card virtual machines virtualize line cards, control card virtual machine virtualize control cards, etc.); it should be understood that the techniques described herein with reference to a correspondence of software containers 562A-R to VNEs also apply to embodiments where such a finer level of granularity is used.

In certain embodiments, the virtualization layer 554 includes a virtual switch that provides similar forwarding services as a physical Ethernet switch. Specifically, this virtual switch forwards traffic between software containers 562A-R and the NIC(s) 544, as well as optionally between the software containers 562A-R; in addition, this virtual switch may enforce network isolation between the VNEs 560A-R that by policy are not permitted to communicate with each other (e.g., by honoring virtual local area networks (VLANs)).

The third exemplary ND implementation in FIG. 5A is a hybrid network device 506, which includes both custom ASICs/proprietary OS and COTS processors/standard OS in a single ND or a single card within an ND. In certain embodiments of such a hybrid network device, a platform VM (i.e., a VM that that implements the functionality of the special-purpose network device 502) could provide for para-virtualization to the networking hardware present in the hybrid network device 506.

Regardless of the above exemplary implementations of an ND, when a single one of multiple VNEs implemented by an ND is being considered (e.g., only one of the VNEs is part of a given virtual network) or where only a single VNE is currently being implemented by an ND, the shortened term network element (NE) is sometimes used to refer to that VNE. Also in all of the above exemplary implementations, each of the VNEs (e.g., VNE(s) 530A-R, VNEs 560A-R, and those in the hybrid network device 506) receives data on the physical NIs (e.g., 516, 546) and forwards that data out the appropriate ones of the physical NIs (e.g., 516, 546). For example, a VNE implementing IP router functionality forwards IP packets on the basis of some of the IP header information in the IP packet; where IP header information includes source IP address, destination IP address, source port, destination port (where “source port” and “destination port” refer herein to protocol ports, as opposed to physical ports of a ND), transport protocol (e.g., user datagram protocol (UDP) (RFC 768, 2460, 2675, 4113, and 5405), Transmission Control Protocol (TCP) (RFC 793 and 1180), and differentiated services (DSCP) values (RFC 2474, 2475, 2597, 2983, 3086, 3140, 3246, 3247, 3260, 4594, 5865, 3289, 3290, and 3317).

FIG. 5C illustrates various exemplary ways in which VNEs may be coupled according to some embodiments of the invention. FIG. 5C shows VNEs 570A.1-570A.P (and optionally VNEs 570A.Q-570A.R) implemented in ND 500A and VNE 570H.1 in ND 500H. In FIG. 5C, VNEs 570A.1-P are separate from each other in the sense that they can receive packets from outside ND 500A and forward packets outside of ND 500A; VNE 570A.1 is coupled with VNE 570H.1, and thus they communicate packets between their respective NDs; VNE 570A.2-570A.3 may optionally forward packets between themselves without forwarding them outside of the ND 500A; and VNE 570A.P may optionally be the first in a chain of VNEs that includes VNE 570A.Q followed by VNE 570A.R (this is sometimes referred to as dynamic service/function chaining, where each of the VNEs in the series of VNEs provides a different service/function—e.g., one or more layer 4-7 network services/functions). While FIG. 5C illustrates various exemplary relationships between the VNEs, alternative embodiments may support other relationships (e.g., more/fewer VNEs, more/fewer dynamic service/function chains, multiple different dynamic service/function chains with some common VNEs and some different VNEs).

The NDs of FIG. 5A, for example, may form part of the Internet or a private network; and other electronic devices (not shown; such as end user devices including workstations, laptops, netbooks, tablets, palm tops, mobile phones, smartphones, tablets, multimedia phones, Voice Over Internet Protocol (VOIP) phones, terminals, portable media players, GPS units, wearable devices, gaming systems, set-top boxes, Internet enabled household appliances) may be coupled to the network (directly or through other networks such as access networks) to communicate over the network (e.g., the Internet or virtual private networks (VPNs) overlaid on (e.g., tunneled through) the Internet) with each other (directly or through servers) and/or access content and/or services. Such content and/or services are typically provided by one or more servers (not shown) belonging to a service/content provider or one or more end user devices (not shown) participating in a peer-to-peer (P2P) service, and may include, for example, public webpages (e.g., free content, store fronts, search services), private webpages (e.g., username/password accessed webpages providing email services), and/or corporate networks over VPNs. For instance, end user devices may be coupled (e.g., through customer premise equipment coupled to an access network (wired or wirelessly)) to edge NDs, which are coupled (e.g., through one or more core NDs) to other edge NDs, which are coupled to electronic devices acting as servers. However, through compute and storage virtualization, one or more of the electronic devices operating as the NDs in FIG. 5A may also host one or more such servers (e.g., in the case of the general purpose network device 504, one or more of the software containers 562A-R may operate as servers; the same would be true for the hybrid network device 506; in the case of the special-purpose network device 502, one or more such servers could also be run on a virtualization layer executed by the compute resource(s) 512); in which case the servers are said to be co-located with the VNEs of that ND.

A virtual network is a logical abstraction of a physical network (such as that in FIG. 5A) that provides network services (e.g., L2 and/or L3 services). A virtual network can be implemented as an overlay network (sometimes referred to as a network virtualization overlay) that provides network services (e.g., layer 2 (L2, data link layer) and/or layer 3 (L3, network layer) services) over an underlay network (e.g., an L3 network, such as an Internet Protocol (IP) network that uses tunnels (e.g., generic routing encapsulation (GRE), layer 2 tunneling protocol (L2TP), IPSec) to create the overlay network).

A network virtualization edge (NVE) sits at the edge of the underlay network and participates in implementing the network virtualization; the network-facing side of the NVE uses the underlay network to tunnel frames to and from other NVEs; the outward-facing side of the NVE sends and receives data to and from systems outside the network. A virtual network instance (VNI) is a specific instance of a virtual network on a NVE (e.g., a NE/VNE on an ND, a part of a NE/VNE on a ND where that NE/VNE is divided into multiple VNEs through emulation); one or more VNIs can be instantiated on an NVE (e.g., as different VNEs on an ND). A virtual access point (VAP) is a logical connection point on the NVE for connecting external systems to a virtual network; a VAP can be physical or virtual ports identified through logical interface identifiers (e.g., a VLAN ID).

Examples of network services include: 1) an Ethernet LAN emulation service (an Ethernet-based multipoint service similar to an Internet Engineering Task Force (IETF) Multiprotocol Label Switching (MPLS) or Ethernet VPN (EVPN) service) in which external systems are interconnected across the network by a LAN environment over the underlay network (e.g., an NVE provides separate L2 VNIs (virtual switching instances) for different such virtual networks, and L3 (e.g., IP/MPLS) tunneling encapsulation across the underlay network); and 2) a virtualized IP forwarding service (similar to IETF IP VPN (e.g., Border Gateway Protocol (BGP)/MPLS IPVPN RFC 4364) from a service definition perspective) in which external systems are interconnected across the network by an L3 environment over the underlay network (e.g., an NVE provides separate L3 VNIs (forwarding and routing instances) for different such virtual networks, and L3 (e.g., IP/MPLS) tunneling encapsulation across the underlay network)). Network services may also include quality of service capabilities (e.g., traffic classification marking, traffic conditioning and scheduling), security capabilities (e.g., filters to protect customer premises from network—originated attacks, to avoid malformed route announcements), and management capabilities (e.g., full detection and processing).

FIG. 5D illustrates a network with a single network element on each of the NDs of FIG. 5A, and within this straight forward approach contrasts a traditional distributed approach (commonly used by traditional routers) with a centralized approach for maintaining reachability and forwarding information (also called network control), according to some embodiments of the invention. Specifically, FIG. 5D illustrates network elements (NEs) 570A-H with the same connectivity as the NDs 500A-H of FIG. 5A.

FIG. 5D illustrates that the distributed approach 572 distributes responsibility for generating the reachability and forwarding information across the NEs 570A-H; in other words, the process of neighbor discovery and topology discovery is distributed.

For example, where the special-purpose network device 502 is used, the control communication and configuration module(s) 532A-R of the ND control plane 524 typically include a reachability and forwarding information module to implement one or more routing protocols (e.g., an exterior gateway protocol such as Border Gateway Protocol (BGP) (RFC 4271), Interior Gateway Protocol(s) (IGP) (e.g., Open Shortest Path First (OSPF) (RFC 2328 and 5340), Intermediate System to Intermediate System (IS-IS) (RFC 1142), Routing Information Protocol (RIP) (version 1 RFC 1058, version 2 RFC 2453, and next generation RFC 2080)), Label Distribution Protocol (LDP) (RFC 5036), Resource Reservation Protocol (RSVP) (RFC 2205, 2210, 2211, 2212, as well as RSVP-Traffic Engineering (TE): Extensions to RSVP for LSP Tunnels RFC 3209, Generalized Multi-Protocol Label Switching (GMPLS) Signaling RSVP-TE RFC 3473, RFC 3936, 4495, and 4558)) that communicate with other NEs to exchange routes, and then selects those routes based on one or more routing metrics. Thus, the NEs 570A-H (e.g., the compute resource(s) 512 executing the control communication and configuration module(s) 532A-R) perform their responsibility for participating in controlling how data (e.g., packets) is to be routed (e.g., the next hop for the data and the outgoing physical NI for that data) by distributively determining the reachability within the network and calculating their respective forwarding information. Routes and adjacencies are stored in one or more routing structures (e.g., Routing Information Base (RIB), Label Information Base (LIB), one or more adjacency structures) on the ND control plane 524. The ND control plane 524 programs the ND forwarding plane 526 with information (e.g., adjacency and route information) based on the routing structure(s). For example, the ND control plane 524 programs the adjacency and route information into one or more forwarding table(s) 534A-R (e.g., Forwarding Information Base (FIB), Label Forwarding Information Base (LFIB), and one or more adjacency structures) on the ND forwarding plane 526. For layer 2 forwarding, the ND can store one or more bridging tables that are used to forward data based on the layer 2 information in that data. While the above example uses the special-purpose network device 502, the same distributed approach 572 can be implemented on the general purpose network device 504 and the hybrid network device 506.

FIG. 5D illustrates that a centralized approach 574 (also known as software defined networking (SDN)) that decouples the system that makes decisions about where traffic is sent from the underlying systems that forwards traffic to the selected destination. The illustrated centralized approach 574 has the responsibility for the generation of reachability and forwarding information in a centralized control plane 576 (sometimes referred to as a SDN control module, controller, network controller, OpenFlow controller, SDN controller, control plane node, network virtualization authority, or management control entity), and thus the process of neighbor discovery and topology discovery is centralized. The centralized control plane 576 has a south bound interface 582 with a data plane 580 (sometime referred to the infrastructure layer, network forwarding plane, or forwarding plane (which should not be confused with a ND forwarding plane)) that includes the NEs 570A-H (sometimes referred to as switches, forwarding elements, data plane elements, or nodes). The centralized control plane 576 includes a network controller 578, which includes a centralized reachability and forwarding information module 579 that determines the reachability within the network and distributes the forwarding information to the NEs 570A-H of the data plane 580 over the south bound interface 582 (which may use the OpenFlow protocol). Thus, the network intelligence is centralized in the centralized control plane 576 executing on electronic devices that are typically separate from the NDs. In one embodiment, centralized reachability and forwarding information module 579 includes functions of packet dispatcher 140 as illustrated in FIG. 1.

For example, where the special-purpose network device 502 is used in the data plane 580, each of the control communication and configuration module(s) 532A-R of the ND control plane 524 typically include a control agent that provides the VNE side of the south bound interface 582. In this case, the ND control plane 524 (the compute resource(s) 512 executing the control communication and configuration module(s) 532A-R) performs its responsibility for participating in controlling how data (e.g., packets) is to be routed (e.g., the next hop for the data and the outgoing physical NI for that data) through the control agent communicating with the centralized control plane 576 to receive the forwarding information (and in some cases, the reachability information) from the centralized reachability and forwarding information module 579 (it should be understood that in some embodiments of the invention, the control communication and configuration module(s) 532A-R, in addition to communicating with the centralized control plane 576, may also play some role in determining reachability and/or calculating forwarding information—albeit less so than in the case of a distributed approach; such embodiments are generally considered to fall under the centralized approach 574, but may also be considered a hybrid approach).

While the above example uses the special-purpose network device 502, the same centralized approach 574 can be implemented with the general purpose network device 504 (e.g., each of the VNE 560A-R performs its responsibility for controlling how data (e.g., packets) is to be routed (e.g., the next hop for the data and the outgoing physical NI for that data) by communicating with the centralized control plane 576 to receive the forwarding information (and in some cases, the reachability information) from the centralized reachability and forwarding information module 579; it should be understood that in some embodiments of the invention, the VNEs 560A-R, in addition to communicating with the centralized control plane 576, may also play some role in determining reachability and/or calculating forwarding information—albeit less so than in the case of a distributed approach) and the hybrid network device 506. In fact, the use of SDN techniques can enhance the NFV techniques typically used in the general purpose network device 504 or hybrid network device 506 implementations as NFV is able to support SDN by providing an infrastructure upon which the SDN software can be run, and NFV and SDN both aim to make use of commodity server hardware and physical switches.

FIG. 5D also shows that the centralized control plane 576 has a north bound interface 584 to an application layer 586, in which resides application(s) 588. The centralized control plane 576 has the ability to form virtual networks 592 (sometimes referred to as a logical forwarding plane, network services, or overlay networks (with the NEs 570A-H of the data plane 580 being the underlay network)) for the application(s) 588. Thus, the centralized control plane 576 maintains a global view of all NDs and configured NEs/VNEs, and it maps the virtual networks to the underlying NDs efficiently (including maintaining these mappings as the physical network changes either through hardware (ND, link, or ND component) failure, addition, or removal).

While FIG. 5D shows the distributed approach 572 separate from the centralized approach 574, the effort of network control may be distributed differently or the two combined in certain embodiments of the invention. For example: 1) embodiments may generally use the centralized approach (SDN) 574, but have certain functions delegated to the NEs (e.g., the distributed approach may be used to implement one or more of fault monitoring, performance monitoring, protection switching, and primitives for neighbor and/or topology discovery); or 2) embodiments of the invention may perform neighbor discovery and topology discovery via both the centralized control plane and the distributed protocols, and the results compared to raise exceptions where they do not agree. Such embodiments are generally considered to fall under the centralized approach 574, but may also be considered a hybrid approach.

While FIG. 5D illustrates the simple case where each of the NDs 500A-H implements a single NE 570A-H, it should be understood that the network control approaches described with reference to FIG. 5D also work for networks where one or more of the NDs 500A-H implement multiple VNEs (e.g., VNEs 530A-R, VNEs 560A-R, those in the hybrid network device 506). Alternatively or in addition, the network controller 578 may also emulate the implementation of multiple VNEs in a single ND. Specifically, instead of (or in addition to) implementing multiple VNEs in a single ND, the network controller 578 may present the implementation of a VNE/NE in a single ND as multiple VNEs in the virtual networks 592 (all in the same one of the virtual network(s) 592, each in different ones of the virtual network(s) 592, or some combination). For example, the network controller 578 may cause an ND to implement a single VNE (a NE) in the underlay network, and then logically divide up the resources of that NE within the centralized control plane 576 to present different VNEs in the virtual network(s) 592 (where these different VNEs in the overlay networks are sharing the resources of the single VNE/NE implementation on the ND in the underlay network).

On the other hand, FIGS. 5E and 5F respectively illustrate exemplary abstractions of NEs and VNEs that the network controller 578 may present as part of different ones of the virtual networks 592. FIG. 5E illustrates the simple case of where each of the NDs 500A-H implements a single NE 570A-H (see FIG. 5D), but the centralized control plane 576 has abstracted multiple of the NEs in different NDs (the NEs 570A-C and G-H) into (to represent) a single NE 5701 in one of the virtual network(s) 592 of FIG. 5D, according to some embodiments of the invention. FIG. 5E shows that in this virtual network, the NE 5701 is coupled to NE 570D and 570F, which are both still coupled to NE 570E.

FIG. 5F illustrates a case where multiple VNEs (VNE 570A.1 and VNE 570H.1) are implemented on different NDs (ND 500A and ND 500H) and are coupled to each other, and where the centralized control plane 576 has abstracted these multiple VNEs such that they appear as a single VNE 570T within one of the virtual networks 592 of FIG. 5D, according to some embodiments of the invention. Thus, the abstraction of a NE or VNE can span multiple NDs.

While some embodiments of the invention implement the centralized control plane 576 as a single entity (e.g., a single instance of software running on a single electronic device), alternative embodiments may spread the functionality across multiple entities for redundancy and/or scalability purposes (e.g., multiple instances of software running on different electronic devices).

While some embodiments of the invention implement the centralized control plane 576 as a single entity (e.g., a single instance of software running on a single electronic device), alternative embodiments may spread the functionality across multiple entities for redundancy and/or scalability purposes (e.g., multiple instances of software running on different electronic devices).

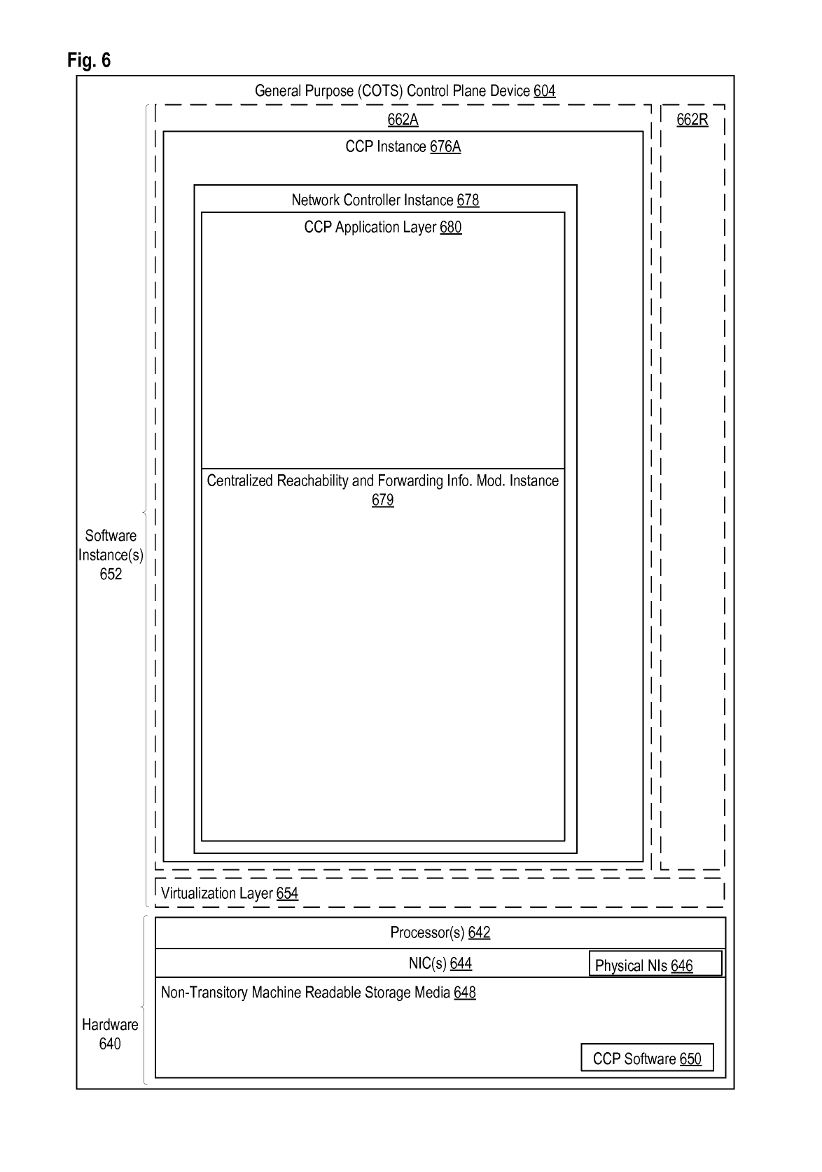

Similar to the network device implementations, the electronic device(s) running the centralized control plane 576, and thus the network controller 578 including the centralized reachability and forwarding information module 579, may be implemented a variety of ways (e.g., a special purpose device, a general-purpose (e.g., COTS) device, or hybrid device). These electronic device(s) would similarly include compute resource(s), a set or one or more physical NICs, and a non-transitory machine-readable storage medium having stored thereon the centralized control plane software. For instance, FIG. 6 illustrates, a general purpose control plane device 604 including hardware 640 comprising a set of one or more processor(s) 642 (which are often COTS processors) and network interface controller(s) 644 (NICs; also known as network interface cards) (which include physical NIs 646), as well as non-transitory machine readable storage media 648 having stored therein centralized control plane (CCP) software 650. The CCP software 650 may include software to execute functions of a part or all of the packet dispatcher 140 according to one embodiment of the invention.

In embodiments that use compute virtualization, the processor(s) 642 typically execute software to instantiate a virtualization layer 654 and software container(s) 662A-R (e.g., with operating system-level virtualization, the virtualization layer 654 represents the kernel of an operating system (or a shim executing on a base operating system) that allows for the creation of multiple software containers 662A-R (representing separate user space instances and also called virtualization engines, virtual private servers, or jails) that may each be used to execute a set of one or more applications; with full virtualization, the virtualization layer 654 represents a hypervisor (sometimes referred to as a virtual machine monitor (VMM)) or a hypervisor executing on top of a host operating system, and the software containers 662A-R each represent a tightly isolated form of software container called a virtual machine that is run by the hypervisor and may include a guest operating system; with para-virtualization, an operating system or application running with a virtual machine may be aware of the presence of virtualization for optimization purposes). Again, in embodiments where compute virtualization is used, during operation an instance of the CCP software 650 (illustrated as CCP instance 676A) is executed within the software container 662A on the virtualization layer 654. In embodiments where compute virtualization is not used, the CCP instance 676A on top of a host operating system is executed on the “bare metal” general purpose control plane device 604. The instantiation of the CCP instance 676A, as well as the virtualization layer 654 and software containers 662A-R if implemented, are collectively referred to as software instance(s) 652.

In some embodiments, the CCP instance 676A includes a network controller instance 678. The network controller instance 678 includes a centralized reachability and forwarding information module instance 679 (which is a middleware layer providing the context of the network controller 578 to the operating system and communicating with the various NEs), and an CCP application layer 680 (sometimes referred to as an application layer) over the middleware layer (providing the intelligence required for various network operations such as protocols, network situational awareness, and user-interfaces). At a more abstract level, this CCP application layer 680 within the centralized control plane 576 works with virtual network view(s) (logical view(s) of the network) and the middleware layer provides the conversion from the virtual networks to the physical view.

The centralized control plane 576 transmits relevant messages to the data plane 580 based on CCP application layer 680 calculations and middleware layer mapping for each flow. A flow may be defined as a set of packets whose headers match a given pattern of bits; in this sense, traditional IP forwarding is also flow-based forwarding where the flows are defined by the destination IP address for example; however, in other implementations, the given pattern of bits used for a flow definition may include more fields (e.g., 10 or more) in the packet headers. Different NDs/NEs/VNEs of the data plane 580 may receive different messages, and thus different forwarding information. The data plane 580 processes these messages and programs the appropriate flow information and corresponding actions in the forwarding tables (sometime referred to as flow tables) of the appropriate NE/VNEs, and then the NEs/VNEs map incoming packets to flows represented in the forwarding tables and forward packets based on the matches in the forwarding tables.

Standards such as OpenFlow define the protocols used for the messages, as well as a model for processing the packets. The model for processing packets includes header parsing, packet classification, and making forwarding decisions. Header parsing describes how to interpret a packet based upon a well-known set of protocols. Some protocol fields are used to build a match structure (or key) that will be used in packet classification (e.g., a first key field could be a source media access control (MAC) address, and a second key field could be a destination MAC address).

Packet classification involves executing a lookup in memory to classify the packet by determining which entry (also referred to as a forwarding table entry or flow entry) in the forwarding tables best matches the packet based upon the match structure, or key, of the forwarding table entries. It is possible that many flows represented in the forwarding table entries can correspond/match to a packet; in this case the system is typically configured to determine one forwarding table entry from the many according to a defined scheme (e.g., selecting a first forwarding table entry that is matched). Forwarding table entries include both a specific set of match criteria (a set of values or wildcards, or an indication of what portions of a packet should be compared to a particular value/values/wildcards, as defined by the matching capabilities—for specific fields in the packet header, or for some other packet content), and a set of one or more actions for the data plane to take on receiving a matching packet. For example, an action may be to push a header onto the packet, for the packet using a particular port, flood the packet, or simply drop the packet. Thus, a forwarding table entry for IPv4/IPv6 packets with a particular transmission control protocol (TCP) destination port could contain an action specifying that these packets should be dropped.

Making forwarding decisions and performing actions occurs, based upon the forwarding table entry identified during packet classification, by executing the set of actions identified in the matched forwarding table entry on the packet.

However, when an unknown packet (for example, a “missed packet” or a “match-miss” as used in OpenFlow parlance) arrives at the data plane 680, the packet (or a subset of the packet header and content) is typically forwarded to the centralized control plane 676. The centralized control plane 676 will then program forwarding table entries into the data plane 680 to accommodate packets belonging to the flow of the unknown packet. Once a specific forwarding table entry has been programmed into the data plane 680 by the centralized control plane 676, the next packet with matching credentials will match that forwarding table entry and take the set of actions associated with that matched entry.

A network interface (NI) may be physical or virtual; and in the context of IP, an interface address is an IP address assigned to a NI, be it a physical NI or virtual NI. A virtual NI may be associated with a physical NI, with another virtual interface, or stand on its own (e.g., a loopback interface, a point-to-point protocol interface). A NI (physical or virtual) may be numbered (a NI with an IP address) or unnumbered (a NI without an IP address). A loopback interface (and its loopback address) is a specific type of virtual NI (and IP address) of a NE/VNE (physical or virtual) often used for management purposes; where such an IP address is referred to as the nodal loopback address. The IP address(es) assigned to the NI(s) of a ND are referred to as IP addresses of that ND; at a more granular level, the IP address(es) assigned to NI(s) assigned to a NE/VNE implemented on a ND can be referred to as IP addresses of that NE/VNE.

Each VNE (e.g., a virtual router, a virtual bridge (which may act as a virtual switch instance in a Virtual Private LAN Service (VPLS) (RFC 4761 and 4762) is typically independently administrable. For example, in the case of multiple virtual routers, each of the virtual routers may share system resources but is separate from the other virtual routers regarding its management domain, AAA (authentication, authorization, and accounting) name space, IP address, and routing database(s). Multiple VNEs may be employed in an edge ND to provide direct network access and/or different classes of services for subscribers of service and/or content providers.

Within certain NDs, “interfaces” that are independent of physical NIs may be configured as part of the VNEs to provide higher-layer protocol and service information (e.g., Layer 3 addressing). The subscriber records in the AAA server identify, in addition to the other subscriber configuration requirements, to which context (e.g., which of the VNEs/NEs) the corresponding subscribers should be bound within the ND. As used herein, a binding forms an association between a physical entity (e.g., physical NI, channel) or a logical entity (e.g., circuit such as a subscriber circuit or logical circuit (a set of one or more subscriber circuits)) and a context's interface over which network protocols (e.g., routing protocols, bridging protocols) are configured for that context. Subscriber data flows on the physical entity when some higher-layer protocol interface is configured and associated with that physical entity.

While the flow diagrams in the figures herein above show a particular order of operations performed by certain embodiments of the invention, it should be understood that such order is exemplary (e.g., alternative embodiments may perform the operations in a different order, combine certain operations, overlap certain operations, etc.).

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. A method of packet processing implemented in an electronic device, the method comprising:
storing received packets in a plurality of packet buffers based on hashing the packets, wherein each of the plurality of packet buffers is implemented as a hash bucket of a hash table;
identifying, from the plurality of packet buffers, a packet buffer that has stored packets;
selecting a first processing thread from a plurality of processing threads of the electronic device based on a load balancing mechanism;
forwarding a plurality of packets from the identified packet buffer to the first processing thread;
setting an indication that the identified packet buffer is mapped to the first processing thread;
determining that the first processing thread has completed processing the plurality of packets;
selecting either the first processing thread or a second processing thread from the plurality of processing threads for processing subsequent packets from the identified packet buffer based on the load balancing mechanism in response to determining that the first processing thread has completed processing the plurality of packets and that the identified packet buffer has stored the subsequent packets; and
maintaining or updating the indication based on the selection of either the first processing thread or the second processing thread.

2. The method of claim 1, wherein the load balancing mechanism is a type of round-robin scheduling.

3. The method of claim 1, wherein setting the indication that the identified packet buffer is mapped to the first processing thread comprises:
setting a bit vector of the identified packet buffer to map the identified packet buffer to the first processing thread.

4. The method of claim 1, wherein determining that the first processing thread has completed processing the plurality of packets comprises:
monitoring a counter of packets from the identified packet buffer that are being processed or waiting to be processed;
decrementing the counter with each completed processing of a packet from the identified packet buffer; and
determining that the first processing thread has completed processing the plurality of packets when the counter equals zero.

5. The method of claim 1, further comprising:
determining that a length of a queue of the identified packet buffer is over a threshold for a period of time,
wherein forwarding the plurality of packets from the identified packet buffer to the first processing thread comprises forwarding the packets one packet at a time to the first processing thread.

6. The method of claim 5, wherein the length of the queue of the identified packet buffer is determined by calculating an exponentially weighted moving average (EWMA) of the queue.

7. The method of claim 1, wherein forwarding the plurality of packets from the identified packet buffer to the first processing thread further comprises:
assigning, to each of the plurality of packets, a packet buffer identifier indicating the identified packet buffer.

8. The method of claim 1, wherein each of the received packets is assigned a unique sequence number based on an order of the packets being received at the electronic device.

9. The method of claim 1, wherein the electronic device is a forwarding element of a software-defined networking (SDN) system.

10. The method of claim 1, wherein the electronic device is a general purpose network device of a system implementing network function virtualization (NFV).

11. An electronic device, comprising:
a processor including a plurality of processing threads; and
a non-transitory machine-readable storage medium coupled to the processor, the non-transitory machine-readable storage medium containing instructions executable by the processor, wherein the electronic device is operative to:
store received packets in a plurality of packet buffers based on hashing the packets, wherein each of the plurality of packet buffers is implemented as a hash bucket of a hash table,
identify, from the plurality of packet buffers, a packet buffer that has stored packets,
select a first processing thread from the plurality of processing threads based on a load balancing mechanism,
forward a plurality of packets from the identified packet buffer to the first processing thread,
set an indication that the identified packet buffer is mapped to the first processing thread,
determine that the first processing thread has completed processing the plurality of packets,
select either the first processing thread or a second processing thread from the plurality of processing threads for processing subsequent packets from the identified packet buffer based on the load balancing mechanism in response to the determination that the first processing thread has completed processing the plurality of packets and that the identified packet buffer has stored the subsequent packets, and
maintain or update the indication based on the selection of either the first processing thread or the second processing thread.

12. The electronic device of claim 11, wherein the determination of the first processing thread having completed processing the plurality of packets is performed through the electronic device being operative to:
monitor a counter of packets from the identified packet buffer that are being processed or waiting to be processed,
decrement the counter with each completed processing of a packet from the identified packet buffer, and
determine that the first processing thread has completed processing the plurality of packets when the counter equals zero.

13. The electronic device of claim 11, wherein the electronic device is further operative to:
determine that a length of a queue of the identified packet buffer is over a threshold for a period of time,
wherein the electronic device is operative to forward the plurality of packets from the identified packet buffer to the first processing thread by forwarding the packets one packet at a time to the first processing thread.

14. The electronic device of claim 11, wherein the electronic device is further operative to assign a unique sequence number to each of the received packets based on an order of the packets being received at the electronic device.

15. The electronic device of claim 11, wherein the electronic device is a forwarding element of a software-defined networking (SDN) system.

16. The electronic device of claim 11, wherein the electronic device is a general purpose network device of a system implementing network function virtualization (NFV).

17. A non-transitory machine-readable storage medium having instructions stored therein, which when executed by a processor, cause the processor to perform operations in an electronic device, the operations comprising:
storing received packets in a plurality of packet buffers based on hashing the packets, wherein each of the plurality of packet buffers is implemented as a hash bucket of a hash table;
identifying, from the plurality of packet buffers, a packet buffer that has stored packets;
selecting a first processing thread from a plurality of processing threads of the electronic device based on a load balancing mechanism;
forwarding a plurality of packets from the identified packet buffer to the first processing thread;
setting an indication that the identified packet buffer is mapped to the first processing thread;
determining that the first processing thread has completed processing the plurality of packets;
selecting either the first processing thread or a second processing thread from the plurality of processing threads for processing subsequent packets from the identified packet buffer based on the load balancing mechanism in response to determining that the first processing thread has completed processing the plurality of packets and that the identified packet buffer has stored the subsequent packets; and
maintaining or updating the indication based on the selection of either the first processing thread or the second processing thread.

18. The non-transitory machine-readable storage medium of claim 17, wherein setting the indication that the identified packet buffer is mapped to the first processing thread comprises:
setting a bit vector of the identified packet buffer to map the identified packet buffer to the first processing thread.

19. The non-transitory machine-readable storage medium of claim 17, wherein forwarding the plurality of packets from the identified packet buffer to the first processing thread comprises:
assigning, to each of the plurality of packets, a packet buffer identifier indicating the identified packet buffer.

20. The non-transitory machine-readable storage medium of claim 17, wherein each of the received packets is assigned a unique sequence number based on an order of the packets being received at the electronic device.
